(19) United States
(12) Patent Application Publication
(10) Pub. No.: US 2014/0038857 A1
(43) Pub. Date: Feb. 6, 2014

(54) Lost Circulation Material With A Multi-Modal Large Particle Size Distribution

(71) Applicants: Matthew L. Miller, Spring, TX (US); Donald L. Whitfill, Kingwood, TX (US)

(72) Inventors: Matthew L. Miller, Spring, TX (US); Donald L. Whitfill, Kingwood, TX (US)

(21) Appl. No.: 13/563,519

(22) Filed: Jul. 31, 2012

(51) Int. Cl. C09K 8/035

(52) U.S. Cl. CPC C09K 8/035
USPC 507/104

(57) ABSTRACT

Compositions for lost circulation materials (LCM) and methods for using same in drilling and/or completing wellbores that help solve lost circulation problems in a wide range of fracture sizes, thereby advantageously eliminating the need for a variety of products for lost circulation in a field at any one time. An unexpected synergy and improved reduction in lost circulation is obtained. The invention provides specific LCM components in specific ratios that are analogs to lost circulation fractures and that yield superior performance in preventing or alleviating lost circulation in drilling and cementing boreholes. The invention compositions have a multi-modal particle size distribution (PSD) which provides a higher concentration of component materials in the same range of two or more fracture widths, thus allowing plugging to occur over a wider range than a single mode or narrow PSD.

### BACKGROUND OF THE INVENTION

1. Field of the Invention

The present invention relates to compositions and methods for drilling and completing boreholes in subterranean formations, particularly hydrocarbon bearing formations. More particularly, the present invention relates to solving lost circulation of drilling and completion fluids in a wide range of fracture sizes in the formation. 2. Description of Relevant Art

In drilling for production of hydrocarbons, global economic conditions require innovative methods to reduce the total cost associated with the construction of a well. A common problem in drilling wells or boreholes in subterranean formations is the loss of circulation (of fluids, such as drilling fluids or muds) in a well or borehole during the drilling. Such lost fluids typically go into fractures induced by excessive mud pressures, into pre-existing open fractures, or into large openings with structural strength in the formation.

A large variety of materials have been used or proposed in attempts to cure lost circulation. Generally, such materials may be divided into four types or categories: fibrous materials, such as shredded automobile tires or sawdust; flaky materials, such as wood chips and mica flakes; granular materials, such as ground nutshells; and slurries, whose strength increases with time after placement, such as hydraulic cement.

Another type of slurry that thickens downhole is made, typically, by dispersing a polyacrylamide in water and then emulsifying the dispersion in a paraffinic mineral oil, typically using a polyamine as an emulsifier. Bentonite is commonly added to such a slurry where it remains in the external or oil phase of the slurry. At normal shear rates, the bentonite rarely if at all contacts the water so the slurry remains relatively thin while being pumped down the drill pipe. At higher shear rates such as prevailing at the drill bit, the emulsion breaks and the bentonite mixes with the water. Crosslinking by the polyacrylamide results in a semi-solid mass that thickens further with the bentonite as it is pumped into cracks and fractures in the formation to block the lost circulation.

U.S. Pat. No. 7,066,285 to Mano Shaarpour provides an improved lost circulation material that comprises a blend of a resilient, angular, carbon-based material and a water-swellable, but not water-soluble, crystalline synthetic polymer. Preferred carbon-based materials comprise resilient graphite carbon particles and ungraphitized carbon particles. Preferred synthetic polymers comprise polyacrylamide, and most preferably a dehydrated crystallized form of cross-linked polyacrlyamide that will readily swell following exposure to water or aqueous based fluids. The patent teaches that each swelling may be delayed by salts in the water, such as the use of brine or addition of calcium chloride.

U.S. Pat. No. 8,043,997 to Donald L. Whitfill, et al. teaches a unique combination of material types and particle sizes for the treatment of lost circulation. The composition of that invention comprises a resilient graphitic carbon having an optimized particle size distribution, and optionally a polymer enhancer, that efficiently seals both small pores (as small as 190 microns) and large fractures (slots as large as about 500 to about 1000 microns), while showing tolerance to high temperatures (as high as about 150° F. to about 250° F.). Flocculants or swellable polymers are taught to be preferred polymers for use in that invention.

In all, a large number of materials have been tried as “lost circulation additives” to drilling fluids to seal off subterranean porous layers and stop or prevent lost circulation of the fluids. To our knowledge, however, there has never been a set of criterion developed whereby the effectiveness of a potential lost circulation material can be predicted before testing. However, the American Petroleum Institute (API) has developed a testing procedure for generally testing lost circulation materials that is set forth in their standard Recommended Practice 13B-1 Annex J (using PPA with a threaded end cap), and API Recommended Practice 13B-2 Annex L (using a slotted disk). The American Petroleum Institute procedure calls for an apparatus comprising a vertical chamber approximately 73 mm in diameter at the bottom for supporting a marble bed approximately 57 mm high. The bottom of the chamber has an outlet in which slotted plates can be inserted and removed to check the effectiveness of the material relative to cracks of various widths. A sample of three thousand five hundred cubic centimeters of drilling mud containing a potential lost circulation additive is poured into the vertical column on top of the marble bed, and the slurry is allowed to drain by gravity until a seal occurs. The amount of effluent is measured, and thereafter a gas pressure is gradually applied on top of the liquid. This gas pressure is continually increased and the amount of effluent is measured when a seal occurs. The seals may be blown out and a new one formed, one or more times, until a maximum of 1000 psi (70.3 KGF per sq. cm.) is developed in the column.

The prior art is replete with test results that have been made of all kinds of lost circulation materials for use as drilling fluid additives—tests in actual wells and/or in screening tests using the above described API testing procedure or a similar one. A maximum particle size for such materials which can be used occurs because of the nozzle sizes which are used in the cutter heads to direct the drilling mud at the cutter teeth. The nozzle sizes used may be as small as 8 mm and so it is highly desirable that the particle size of the lost circulation material not be larger than 8 min so that the material can be universally used. However, this restriction presents the problem that it is necessary to seal openings using particles having a diameter that is less than, or only slightly larger than the width of the hole which the particles are intended to seal. The art has tried to use straw for example having a length greater than 2.54 cm but such materials tend to create plugging and other problems in the recirculating equipment for the drilling fluids.

Drilling fluids are thixotropic and will have a yield point which generally cannot be exceeded without creating drilling problems. For example, high yield points in a fluid result in excessive pressure when pumps are turned off and then back on again to resume circulation. This pressure can result in a greater probability of lost circulation. It is generally considered desirable for drilling muds to develop a controlled yield point such that the drilling fluids will have as great a rock chip suspending capability as is possible during normal operation. Thus, it is highly desirable for lost circulation materials added to the drilling fluid not to have an appreciable effect on the yield point of the drilling fluids. Ground walnut shells are known not to greatly increase the yield point and so they have been used extensively as lost circulation materials. However, ground walnut shells have size and material property limitations.

Although many materials and compositions exist and have been proposed for preventing lost circulation, there continues to be a need for more versatile and better compositions and methods for preventing loss of drilling fluids during drilling and completion operations.

### SUMMARY OF THE INVENTION

The present invention provides compositions or formulations for lost circulation materials, and methods for using such materials in drilling and/or completing wellbores that help solve lost circulation problems in a wide range of fracture sizes. This invention thus provides a logistical advantage of one product sufficing for a variety of lost circulation needs, eliminating the need to have a variety of products for lost circulation in a field at any one time.

Moreover, an unexpected synergy and improved reduction in lost circulation may be obtained with the compositions and methods of the invention, even though the compositions contain materials known to be effective in preventing or alleviating lost circulation, but that are not known to be individually as effective as when used according to the present invention.

The compositions of the present invention comprise specific components in specific ratios that are analogs to lost circulation fractures and that yield superior performance in preventing or alleviating lost circulation in drilling boreholes and in cementing boreholes. The lost circulation material (LCM) composition of the invention has a multi-modal particle size distribution (PSD) design that provides a higher concentration of component materials in the same range of two or more fracture widths, thus allowing plugging to occur over a wider range, than would a single mode or narrow PSD design. Generally, the invention provides a broad particle size distribution so as to cover a range of fracture sizes with the same LCM combination.

### BRIEF DESCRIPTION OF THE DRAWINGS

FIG. 1 is a particle size distribution curve for one example embodiment of the composition of the invention, having 100% by volume of the first formulation, showing ratios and modality.

FIG. 2 is a particle size distribution curve for another example embodiment of the composition of the invention, having 75% by volume of the first formulation combined with 25% by volume of the second formulation, showing ratios and modality.

FIG. 3 is a particle size distribution curve for still another example embodiment of the composition of the invention, having 50% by volume of the first formulation combined with 50% by volume of the second formulation, showing ratios and modality.

FIG. 4 is a particle size distribution curve for still another example embodiment of the composition of the invention, having 25% by volume of the first formulation and 75% by volume of the second formulation, showing ratios and modality.

FIG. 5 is a particle size distribution curve for still another example embodiment of the composition of the invention, having 100% by volume of the second formulation, showing ratios and modality.

FIG. 6 is a bar chart graphing grams of fluid loss versus fracture slot size in a lost circulation fluid test with the first and second formulations of the invention and two prior art lost circulation fluids.

### DETAILED DESCRIPTION OF PREFERRED EMBODIMENTS

Two specific formulations have been found which provide synergy in preventing or alleviating lost circulation in drilling boreholes and in cementing boreholes according to the present invention. The first formulation is a lower cost alternative and the second formulation is a premium alternative. For a third alternative, these two formulations of the invention could be combined.

The first composition of the invention comprises three sizes of walnut pieces—fine (having a one particle size of about 100 microns to about 2,000 microns; medium (having a one particle size in the range of from about 200 microns to about 3000 microns; and coarse (having a one particle size in the range of from about 300 microns to about 4,000 microns)—and three sizes of calcium carbonate—fine (having a one particle size from about 1 micron to about 500 microns); medium (having a one particle size in the range of from about 100 microns to about 1500 microns); and coarse (having a one particle size in the range of from about 500 microns to about 3,000 microns). Concentrations are typically in the range of about 10 lb/bb to about 120 pounds per barrel (lb/bb). The proportions of these components may vary but preferably the formulation will comprise walnut pieces to calcium carbonate in a ratio ranging from about 1:1 to about 10:1 with a preferred distribution of size of walnut pieces being 20-30% fine, 25-35% medium, and 35-45% coarse and a preferred distribution of size of calcium carbonate particles being 30-35% fine, medium, and coarse.

The second composition of the invention comprises three sizes of a resilient graphitic carbon such as STEELSEAL® material available from Halliburton Energy Services, Inc. in Houston, Tex. and Duncan, Okla., preferably STEELSEAL® 1000 with a particle size d50 of about 1000+/−200 microns, STEELSEAL® 400 with a particle size d50 of about 400+/−50 microns, and STEELSEAL® 100 with a particle size d50 of about 100+−25 microns. The second composition of the invention also comprises walnut medium (having a one particle size in the range of from about 200 microns to about 3,000 microns); pecan shell medium (having a one particle size in the range of from about 400 microns to about 3,000 microns); and corn cob 8/14 (having a one particle size range from about 1,500 microns to about 4,000 microns). Concentrations are typically in the range of about 10 pounds per barrel (lb/bbl) to about 120 lb/bbl. The proportions of these components may vary but preferably the formulation will comprise resilient graphitic carbon to walnut medium to pecan shell medium to corn cob in a ratio ranging from about 5 to about 1 to about 2 to about 2 (RGC:WN:P:Corn Cob of 5:1:2:2) with the distribution of size of resilient graphitic carbon being 30-40% fine, 30-40% medium, and 20-30% coarse.

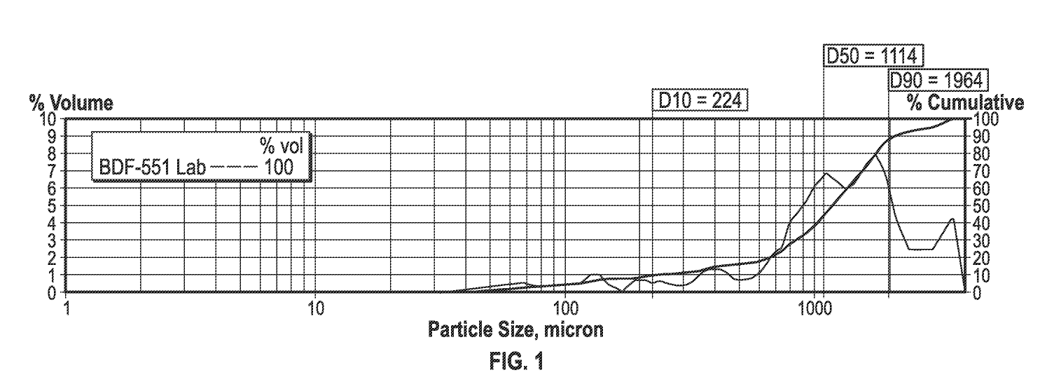

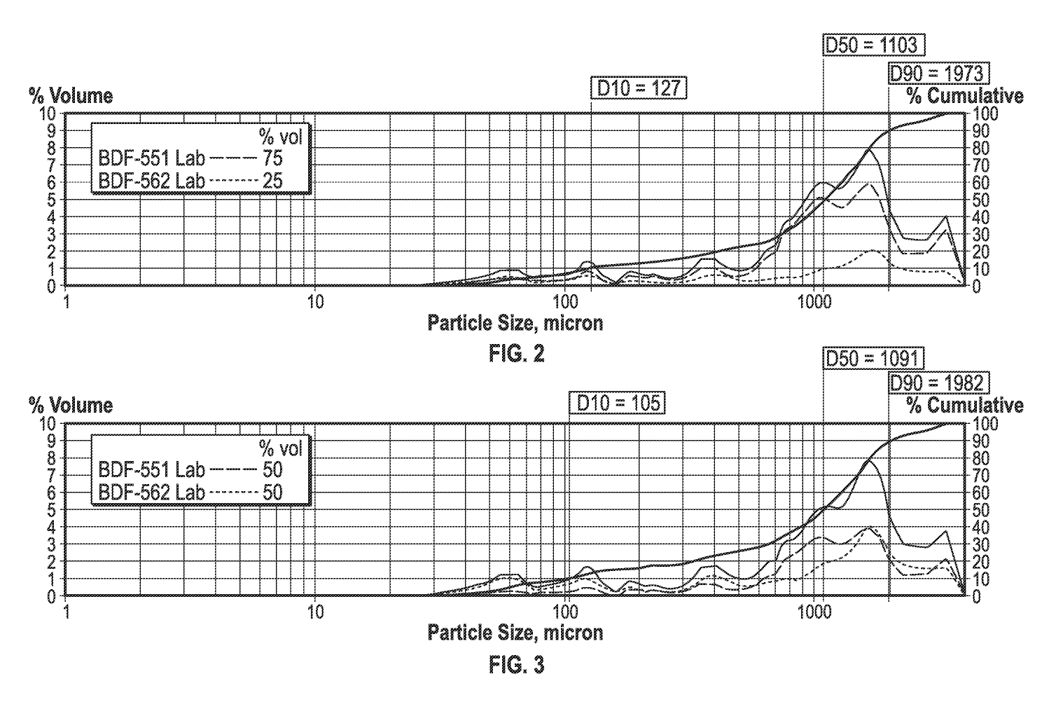

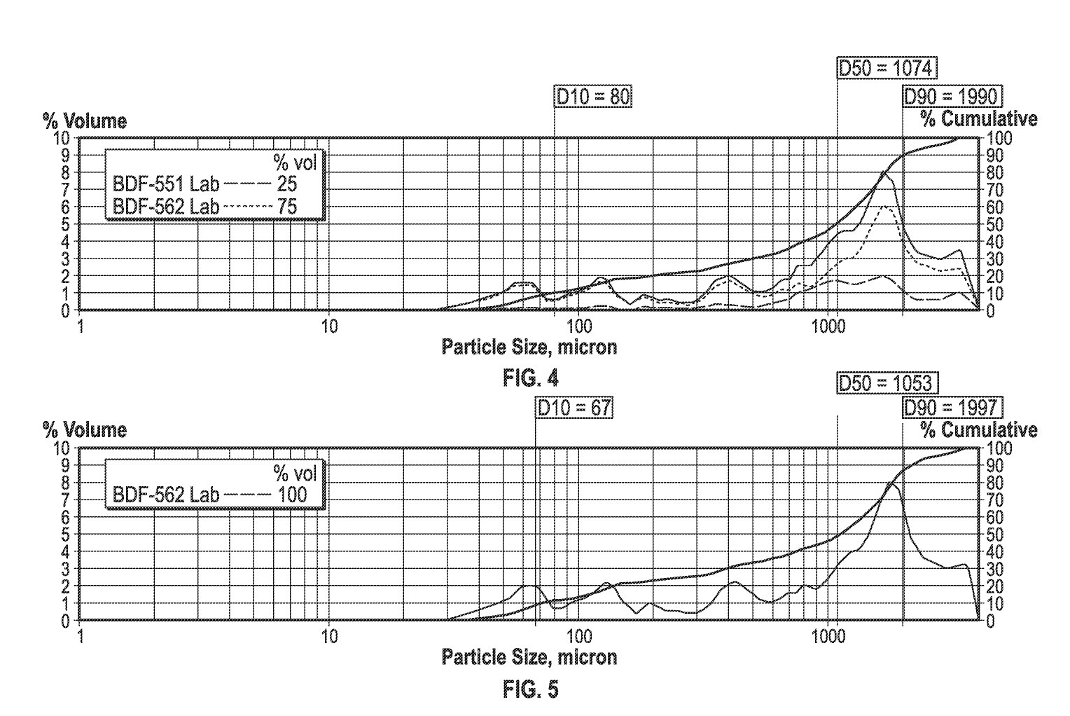

The first and second compositions may be combined in a variety of ratios. For example, a 50:50 combination of one sack of each composition yields a lost circulation material containing 12 different components and six modal peaks as shown in the PSD curve in FIG. 3. The modal peaks are for particle sizes of 60, 150, 400, 1100, 1650, and 3350 microns. Modal peaks occur when particle concentrations are increased relative to particle sizes on either side of the curve. A PSD curve for a 75:25 combination of one sack of each of the first and second compositions of the invention is shown in FIG. 2 and a 25:75 combination of one sack of each of the first and second compositions of the invention is shown in FIG. 4. FIG. 1 provides a PSD curve for the first composition (without any of the second composition) and FIG. 5 provides a PSD curve for the second composition (without any of the first composition).

Laboratory tests were conducted with the first and second formulations above at concentrations of 50 lb/bbl and a pressure differential of 1000 psi. To simulate use in drilling, the test procedure was conducted in accordance with API 13B-1 Annex J as indicated above. Results are shown in TABLES 1 and 2 below.

TABLE 1
Grams of fluid lost before sealing each slotted disk for First Formulation
(low-cost formulation)

| | First Formulation in | | | | | |
|---|---|---|---|---|---|---|
| | Drilling Fluids | | | | | |
| | HYDROGUARD ™ | | BORE-MAX ™ | | ENCORE ™ | |
| Temperature | 150 | 250 | 150 | 250 | 150 | 250 |
| (° F.) | | | | | | |
| 1016 micron | 1.39 | 1.46 | 6.46 | 1.22 | 2.45 | 2.21 |
| slot | | | | | | |
| 1524 micron | 2.23 | 2.42 | 5.81 | 2.81 | 4.05 | 3.37 |
| slot | | | | | | |
| 2032 micron | 2.63 | 2.53 | 5.5 | 3.96 | 5.78 | 2.32 |
| slot | | | | | | |
| 2540 micron | 46.25 | 22.56 | 30.4 | 31.29 | 100.7 | 65.38 |
| slot | | | | | | |
| tapered slot | 8.08 | 78.31 | 33.1 | 19.59 | 8.92 | 9.25 |

In the tables herein, HYDROGUARD™, BORE-MAX™, and ENCORE® are trademarks of Halliburton Energy Services, Inc. and are available from Halliburton Energy Services, Inc. in Houston, Tex. and Duncan, Okla. These are different types of drilling fluids to demonstrate the versatility of the formulations to work in a range of drilling fluids. HYDROGUARD™ fluid is a high salinity water base fluid; BORE_MAX™ fluid is a freshwater based fluid and ENCORE™ fluid is an invert emulsion non-aqueous fluid.

TABLE 2
Grams of fluid lost before sealing each slotted disk for Second
Formulation (premium formulation)

| | Second Formulation in | | | | | |
|---|---|---|---|---|---|---|
| | Drilling Fluids | | | | | |
| | HYDROGUARD ™ | | BORE-MAX ™ | | ENCORE ™ | |
| Temperature | 150 | 250 | 150 | 250 | 150 | 250 |
| (° F.) | | | | | | |
| 1016 micron | 1.83 | 5.31 | 5.75 | 6.76 | 3.02 | 13.5 |
| slot | | | | | | |
| 1524 micron | 3.21 | 6.37 | 4.59 | 6.64 | 4.50 | 3.27 |
| slot | | | | | | |
| 2032 micron | 4.86 | 11.04 | 4.91 | 7.88 | 9.61 | 9.32 |
| slot | | | | | | |
| tapered slot | 11.08 | 24.11 | 35.44 | 21.49 | 8.54 | 19.34 |

Experiments to simulate use of the compositions of the invention in spacers used during cementing of boreholes, were conducted, again using the test procedure set forth in API 13B-1 Annex J as indicated above. Results are shown in TABLES 3 and 4 below.

TABLE 3
Fluid loss results for 50 lb-First Formulation
with Halliburton Cementing Tuned Spacer III

| | | Amount | Slot Size | | Fluid loss |
|---|---|---|---|---|---|
| Test No | LCM | (lb) | (microns) | Slot Type | (gms) |
| 1 | First | 50 | 1500 | Constant | 1.3 |
| | Formulation | | | Area Slot | |
| 2 | First | 50 | 2032 | Constant | 5 |
| | Formulation | | | Area Slot | |
| 3 | First | 50 | 2540 | Constant | 10 |
| | Formulation | | | Area Slot | |
| 4 | First | 50 | 2500-1000 | Tapered Slot | 27 |
| | Formulation | | | | |
| 5 | First | 50 | 3500-2000 | Tapered Slot | 81 |
| | Formulation | | | | |

TABLE 4
Fluid loss results for 50 lb-Second Formulation
with Halliburton Cementing Tuned Spacer III

| | | Amount | Slot Size | | Fluid loss |
|---|---|---|---|---|---|
| Test No | LCM | (lb) | (microns) | Slot Type | (gms) |
| 1 | Second | 50 | 1500 | Constant | 3.5 |
| | Formulation | | | Area Slot | |
| 2 | Second | 50 | 2032 | Constant | 2 |
| | Formulation | | | Area Slot | |
| 3 | Second | 50 | 2540 | Constant | 16 |
| | Formulation | | | Area Slot | |
| 4 | Second | 50 | 2500-1000 | Tapered Slot | 8 |
| | Formulation | | | | |
| 5 | Second | 50 | 3500-2000 | Tapered Slot | 220 |
| | Formulation | | | | |

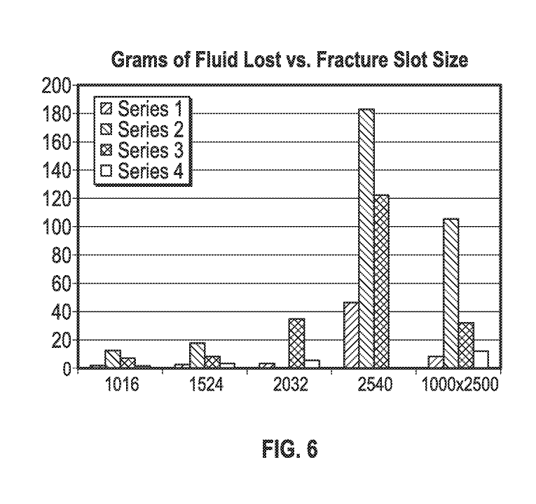

To demonstrate the synergy obtainable with the present invention, tests like the ones reported above were conducted with prior art formulations, in commercial use, specifically “Product A,” a product comprising recycled plastics and recycled cellulosic particles together with other functional additives, and “Product B,” a product comprising a blend of inorganic sealants and bridging agents. The results of these tests with Products A and B are shown in Tables 5 and 6 below. Using data from Tables 1, 2, 5, and 6 herein, a graphic comparison of Product A, Product B, and the first and second formulations of the present invention described above, as lost circulation materials in HYDROGUARD™ drilling fluid at 150° F., was prepared showing the grams of fluid lost versus the fracture slot size for each. This graph is shown in FIG. 6, with Series 1=results for the first formulation of the present invention; Series 2=results for Product A (prior art); Series 3=results for Product B (prior art); and Series 4=results for the second formulation of the present invention. This graph shows significant reduction in fluid lost with the formulations of the invention over a broader range than the prior art products were capable.

TABLE 5
Grams of Fluid lost before sealing each slotted disk for Product A

| | Drilling Fluids | | | | | |
|---|---|---|---|---|---|---|
| | HYDROGUARD ™ | | BORE-MAX ™ | | ENCORE ™ | |
| Temperature | 150 | 250 | 150 | 250 | 150 | 250 |
| (° F.) | | | | | | |
| 1016 micron | 12.34 | 19.73 | 26.84 | 51.48 | 25.05 | 26.03 |
| slot | | | | | | |
| 2032 micron | 17.52 | 72.91 | 57.80 | 72.58 | 24.83 | 147.25 |
| slot | | | | | | |
| 2540 micron | 183.17 | N/C* | N/C | N/C | N/C | N/C |
| slot | | | | | | |
| tapered slot | 105.22 | N/C | 173.38 | 159.37 | 114.19 | 139.83 |

*N/C stands for no control - slot did not plug

TABLE 6
Grams of fluid lost before sealing each disk for Product B\hat{ }

| | Drilling Fluids | | | | | |
|---|---|---|---|---|---|---|
| | HYDROGUARD ™ | | BORE-MAX ™ | | ENCORE ™ | |
| Test | 150 | 250 | 150 | 250 | 150 | 250 |
| temperature, | | | | | | |
| ° F. | | | | | | |
| 1016 micron | 6.51 | 26.21 | 8.47 | 20.96 | 2.47 | 21.41 |
| slot | | | | | | |
| 1524 micron | 7.97 | 30.77 | 9.04 | 77 | 26.34 | 149.81 |
| slot | | | | | | |
| 2032 micron | 34.86 | 119.24 | 7.56 | 90.71 | 101.6 | 209 |
| slot | | | | | | |
| 2540 micron | 121.65 | N/C | 89.66 | N/C | N/C | N/C |
| slot | | | | | | |
| Tapered slot | 31.99 | 95.88 | 66.44 | 178 | 30.64 | 173.2 |

\hat{ }Pressure differential was only 500 psi for this series of tests

Also, field tests were conducted. Specifically, an operator was experiencing lost circulation while drilling the intermediate section of a well in an area known for problems with lost circulation. This section was made up of highly fractured and pressure depleted formations. These formations had been produced for many years. In some wells, the pore pressure had been brought down to 2 lb/gal equivalent. The commercial products being used to alleviate lost circulation came from several different sacks of different products which had to be mixed together for each lost circulation treatment, causing the operator to stop the drilling operation each time, wasting valuable rig time.

The first formulation of the composition of the invention was tried as an alternative lost circulation material (LCM) in this field because this formulation of the invention is made up of some of the same products that were already being used in the commercial LCM but at different material ratios and concentrations believed effective at stopping losses. The formulation of the invention improved reduction of lost circulation. The formulation of the invention included larger material in the mixture than provided in the commercial product. This larger particle size in the formulation of the invention helped plug off larger voids than were being plugged previously with the commercial product. A significant advantage of the formulation of the invention was that it came in one bag and contained all particle sizes necessary for the treatment. The product was delivered in 2000 lb “super sacks.” Time was saved by not having to cut as many sacks and by not requiring extra time to mix additional products or circulate to build the fluid in active pits. The well operator saved mixing time for the LCM pill and significantly reduced drilling fluid losses. Drilling was not stopped as it was with the commercial products, in order to mix the product of the invention in an LCM pill because the product of the invention was all in one bag, saving 4 hours of mixing time per 500 bbl. Drilling also was not stopped to mix new drilling fluid due to drilling fluid losses because the formulation of the invention stopped drilling fluid losses. The formulation of the invention helped seal fissures that might cause lost circulation, thus preventing lost circulation, and saved an additional three hours of mixing time. An added benefit of using the formulation of the invention over the commercial LCM products was the cost—the LCM of the invention was roughly half the price of the commercial LCM products previously being used.

In the field trial of the invention discussed above, a total of seven hours of mixing time was saved by using the product of the invention, and the product of the invention was significantly more effective at stopping losses of drilling fluid. The drilling fluid of the invention cost 42% less than the same amount of the commercial LCM, saving over $20,000 per LCM pill. Logistical advantages also increased efficiency and improved personnel safety at the rig: that is, with the product of the invention in super sacks, the personnel did not have to cut hundreds of sacks, and thus their risk of injury that comes from bending, lifting, and cutting the smaller sacks was reduced. This provided still another added benefit—reduced environmental impact by reducing the amount of trash.

The foregoing description of the invention is intended to be a description of preferred embodiments. Various changes in the details of the described fluids and methods of use can be made without departing from the intended scope of this invention as defined by the appended claims.

What is claimed is:

1. A method for avoiding or reducing lost circulation in a subterranean formation during drilling a borehole in said formation, the method comprising: treating the subterranean formation with a lost circulation material or composition comprising: walnut pieces in three different sizes or size ranges and calcium carbonate particles in three different sizes or size ranges,
wherein the walnut pieces comprise fine pieces having a one particle size of about 100 microns to about 3,000 microns, medium pieces having a one particle size in the range of from about 200 microns to about 3,000 microns, and coarse pieces having a one particle size in the range of from about 300 microns to about 4,000 microns, and
wherein the calcium carbonate particles comprise fine particles having a one particle size from about 1 micron to about 500 microns, medium particles having a one particle size from about 100 microns to about 1500 microns, and coarse particles having a one particle size from about 500 microns to about 3,000 microns.

2. The method of claim 1 wherein the concentration of the lost circulation material is about 10 lb/bb to about 120 lb/bb.

3. The method of claim 1 wherein the proportion of walnut pieces to calcium carbonate particles in the lost circulation material ranges from about 1:1 to about 10:1.

4. The method of claim 1 wherein the distribution of size of walnut pieces in the lost circulation material is about 20-30% fine, 25-35% medium and 35-45% coarse.

5. The method of claim 1 wherein the distribution of size of calcium carbonate particles in the lost circulation material is about one-third fine, about one-third medium, and about one-third coarse.

6. A method for avoiding or reducing lost circulation in a subterranean formation during drilling a borehole in said formation, the method comprising: treating the subterranean formation with a lost circulation material or composition comprising: resilient graphitic carbon material in three different sizes or size ranges; walnut pieces having a one particle size in the range of from about 200 microns to about 3,000 microns; pecan shell medium having a one particle size in the range of from about 400 microns to about 3,000 microns, and corn cob 8/14 particles having a one particle size in the range of from about 1,500 microns to about 4,000 microns;
wherein the resilient graphitic carbon material comprise fine pieces having a one particle size of about 200 microns to about 3,000 microns, medium pieces having a one particle size in the range of from about 1000 microns to about 3,000 microns, and coarse pieces having a one particle size in the range of from about 300 microns to about 4,000 microns.

7. The method of claim 6 wherein the concentration of the lost circulation material is about 10 lb/bb to about 120 lb/bb.

8. The method of claim 6 wherein the proportion of resilient graphitic carbon particles to walnut pieces to pecan shell medium to corn cob material in the lost circulation material ranges from about 5:1:2:2.

9. The method of claim 6 wherein the distribution of size of resilient graphitic carbon in the lost circulation material is about 37.5% fine, 37.5% medium and 25.0% coarse.

10. The method of claim 1 wherein the lost circulation material further comprises mixed therewith a second lost circulation material comprising resilient graphitic carbon material in three different sizes or size ranges; walnut pieces having a one particle size in the range of from about 1,000 microns to about 3,000 microns; pecan shell medium having a one particle size in the range of from about 400 microns to about 3,000 microns, and corn cob 8/14 particles having a one particle size in the range of from about 1,500 microns to about 4,000 microns;
wherein the resilient graphitic carbon material comprise fine pieces having a one particle size of about 1 microns to about 500 microns, medium pieces having a one particle size in the range of from about 50 microns to about 1,000 microns, and coarse pieces having a one particle size in the range of from about 200 microns to about 2,000 microns.

11. The method of claim 10 wherein the second lost circulation material comprises about 25% of the lost circulation material mixture.

12. The method of claim 10 wherein the second lost circulation material comprises about 50% of the lost circulation material mixture.

13. The method of claim 10 wherein the second lost circulation material comprises about 75% of the lost circulation material mixture.

14. The method of claim 10 wherein the concentration of the lost circulation material is about 10 lb/bb to about 120 lb/bb.

15. The method of claim 10 wherein the distribution of size of resilient graphitic carbon in the lost circulation material mixture is about 30-40% fine, 30-40% medium and 20-30% coarse.

16. The method of claim 10 wherein the distribution of size of walnut pieces in the lost circulation material is about 20-30% fine, 25-35% medium and 35-45% coarse.

17. The method of claim 10 wherein the calcium carbonate particles in the lost circulation material mixture is about one-third fine, about one-third medium, and about one-third coarse.

18. The method of claim 10 wherein the proportion of resilient graphitic carbon particles to walnut pieces to pecan shell medium to corn cob material in the lost circulation material mixture ranges from about 5:1:2:2.

19. A lost circulation material or composition comprising: walnut pieces in three different sizes or size ranges and calcium carbonate particles in three different sizes or size ranges,
wherein the walnut pieces comprise fine pieces having a one particle size of about 100 microns to about 2,000 microns, medium pieces having a one particle size in the range of from about 200 microns to about 3,000 microns, and coarse pieces having a one particle size in the range of from about 300 microns to about 4,000 microns, and
wherein the calcium carbonate particles comprise fine particles having a one particle size from about 1 micron to about 500 microns, medium particles having a one particle size from about 100 microns to about 1500 microns, and coarse particles having a one particle size from about 500 microns to about 3,000 microns.

20. A lost circulation material or composition comprising: resilient graphitic carbon material in three different sizes or size ranges; walnut pieces having a one particle size in the range of from about 200 microns to about 3,000 microns; pecan shell medium having a one particle size in the range of from about 400 microns to about 3,000 microns, and corn cob 8/14 particles having a one particle size in the range of from about 1,500 microns to about 4,000 microns;
wherein the resilient graphitic carbon material comprise fine pieces having a one particle size of about 1 microns to about 500 microns, medium pieces having a one particle size in the range of from about 50 microns to about 1,000 microns, and coarse pieces having a one particle size in the range of from about 200 microns to about 2,000 microns.

21. A lost circulation material or composition comprising a mixture of a first and a second lost circulation material or composition,
wherein the first lost circulation material comprises:
walnut pieces in three different sizes or size ranges and calcium carbonate particles in three different sizes or size ranges,
wherein the walnut pieces comprise fine pieces having a one particle size of about 100 microns to about 23,000 microns, medium pieces having a one particle size in the range of from about 200 microns to about 3,000 microns, and coarse pieces having a one particle size in the range of from about 300 microns to about 4,000 microns, and
wherein the calcium carbonate particles comprise fine particles having a one particle size from about 1 micron to about 500 microns, medium particles having a one particle size from about 100 microns to about 1500 microns, and coarse particles having a one particle size from about 5700 microns to about 3,000 microns; and wherein the second lost circulation material comprises:
resilient graphitic carbon material in three different sizes or size ranges;
walnut pieces having a one particle size in the range of from about 200 microns to about 3,000 microns;
pecan shell medium having a one particle size in the range of from about 200 microns to about 3,000 microns, and
corn cob 8/14 particles having a one particle size in the range of from about 1,500 microns to about 4,000 microns;
wherein the resilient graphitic carbon material comprise fine pieces having a one particle size of about 1 microns to about 500 microns, medium pieces having a one particle size in the range of from about 50 microns to about 1,000 microns, and coarse pieces having a one particle size in the range of from about 200 microns to about 2,000 microns.
